(19) United States
(12) Patent Application Publication
(10) Pub. No.: US 2024/0228364 A1
(43) Pub. Date: Jul. 11, 2024

(54) TRANSITION METAL-CONTAINING, ION EXCHANGEABLE COLORED GLASSES

(71) Applicant: CORNING INCORPORATED, CORNING, NY (US)

(72) Inventors: Xiaoju Guo, Pittsford, NY (US); Jeffrey Todd Kohli, Corning, NY (US); John Christopher Mauro, Boalsburg, PA (US); Ronald Leroy Stewart, Fisherville, VA (US)

(21) Appl. No.: 18/429,857

(22) Filed: Feb. 1, 2024

Related U.S. Application Data
(63) Continuation of application No. 14/764,786, filed on Jul. 30, 2015, now Pat. No. 11,926,564.
(60) Provisional application No. 61/759,053, filed on Jan. 31, 2013.

(51) Int. Cl. C03C 3/097; C03C 3/083; C03C 3/085; C03C 3/087; C03C 3/091; C03C 4/02; C03C 21/00

(52) U.S. Cl. CPC C03C 3/097; C03C 3/083; C03C 3/085; C03C 3/087; C03C 3/091; C03C 4/02; C03C 21/002; C03C 2204/04; Y10T 428/315

(57) ABSTRACT

Glasses that can be chemically strengthened and are colored by transition metals. Most of the glasses are black, with some having high damage resistance and compressive surface layers having high compressive stress and depth of layer after ion exchange. These colored glasses do not require a post-forming heat treatment to produce color and are formable by fusions drawing, rolling, slot drawing, and float glass processes.

This application is a continuation of and claims the benefit of priority under 35 U.S.C. § 120 of U.S. patent application Ser. No. 14/764,786 filed on Jul. 30, 2015, which claims the benefit of priority under 35 U.S.C. § 365 of International Patent Application Serial No. PCT/US14/13286 filed on Jan. 28, 2014, which claims the benefit of priority under 35 U.S.C. § 119 of U.S. Provisional Application Ser. No. 61/759,053 filed on Jan. 31, 2013, the content of which is relied upon and incorporated herein by reference in its entirety.

### BACKGROUND

The disclosure relates to glasses that are capable of chemical strengthening by ion exchange and have intrinsic damage resistance. More particularly, the disclosure relates to such glasses that comprise transition metal oxides that act as colorants.

Ion exchangeable glass compositions offer advantages in glass manufacturability and/or final properties compared to previous glass compositions. Such glasses are used in applications such as, but not limited to, cover glasses, windows, enclosures, and the like in a variety of electronic devices, including displays in entertainment and communication devices.

### SUMMARY

Glasses that can be chemically strengthened and are colored by transition metals are provided. Most of the glasses described herein are black, with some having high damage resistance and compressive surface layers having high compressive stress and depth of layer after ion exchange. These colored glasses do not require a post-forming heat treatment to produce color. Based on liquidus data, these glasses are fusion formable. However, other processes, such as rolling, slot drawing, and float glass processes may be used to produce these glasses.

Accordingly, one aspect of the disclosure is to provide a silicate glass having a Vickers crack initiation threshold of at least 15 kgf. The silicate glass comprises: at least about 50 mol % SiO₂; at least about 10 mol % R₂O, wherein R₂O comprises Na₂O; Al₂O₃, wherein −0.5 mol %≤Al₂O₃(mol %)−R₂O(mol %)≤2 mol %; B₂O₃, wherein B₂O₃(mol %)−(R₂O(mol %)—Al₂O₃(mol %))≥4.5 mol %; and at least one transition metal colorant, the transition metal oxide colorant comprising at least one of V₂O₅, NiO, CuO, Cr₂O₃, MnO₂, Fe₂O₃, Co₃O₄, Nb₂O₅, and TiO₂.

A second aspect of the disclosure is to provide a silicate glass having a zircon breakdown temperature that is equal to the temperature at which the silicate glass has a viscosity in a range from about 30 kPoise to about 40 kPoise, and a Vickers crack initiation threshold of at least 15 kgf. The silicate glass comprises: at least about 50 mol % SiO₂; at least about 10 mol % R₂O, wherein R₂O comprises Na₂O; Al₂O₃, wherein Al₂O₃(mol %)<R₂O(mol %); B₂O₃, wherein B₂O₃(mol %)—(R₂O(mol %)—Al₂O₃(mol %))≥2 mol %; and at least one transition metal colorant, the transition metal oxide colorant comprising at least one of V₂O₅, NiO, CuO, Cr₂O₃, MnO₂, Fe₂O₃, Co₃O₄, Nb₂O₅, and TiO₂.

A third aspect of the disclosure is to provide a silicate glass comprising at least about 4% P₂O₅ and at least one transition metal colorant, wherein: [M₂O₃(mol %)/RₓO(mol %)]<1.4; or 1.3<[(P₂O₅(mol %)+R₂O(mol %))/M₂O₃(mol %)]≤2.3, where M₂O₃(mol %)=Al₂O₃(mol %)+B₂O₃(mol %), RₓO is the sum of monovalent and divalent cation oxides present in the silicate glass, and R₂O is the sum of divalent cation oxides present in the silicate glass. The transition metal oxide colorant comprises at least one of V₂O₅, NiO, CuO, Cr₂O₃, MnO₂, Fe₂O₃, Co₃O₄, Nb₂O₅, and TiO₂

These and other aspects, advantages, and salient features will become apparent from the following detailed description, the accompanying drawings, and the appended claims.

### BRIEF DESCRIPTION OF THE DRAWINGS

FIG. 1 is a plot of x-ray diffraction spectra for sample glasses;

FIG. 2 is a ultraviolet-visible-near infrared (UV-Vis-NIR) transmission spectra of sample glasses;

FIG. 3 is a SCE UVC transmission spectra of black glasses based on base glass B;

FIG. 4 is a plot of reflectance color a* and b* results for black glasses based on base glass B;

FIG. 5 is a plot of reflectance color a* and b* results for black glasses based on base glass B; and

FIG. 6 is a plot of Vickers indentation threshold for sample glasses that had been ion exchanged at 410° C. for 2 hours.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range as well as any ranges therebetween. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

As used herein, the terms “glass” and “glasses” includes both glasses and glass ceramics. The terms “glass article” and “glass articles” are used in their broadest sense to include any object made wholly or partly of glass and/or glass ceramic.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

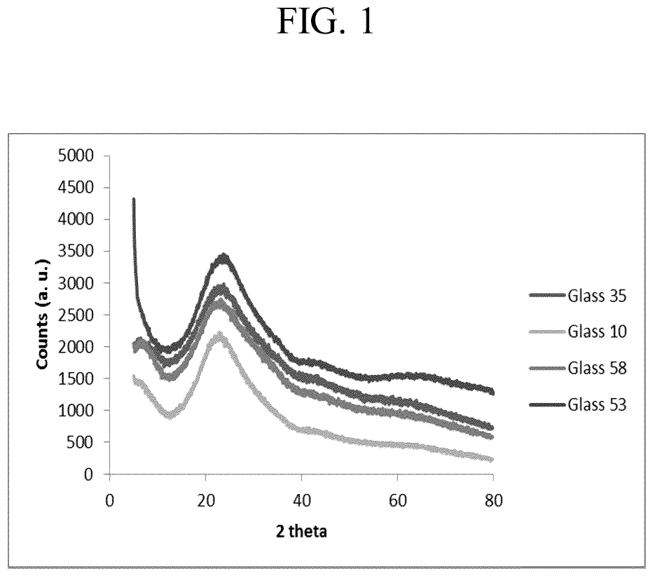

Referring to the drawings in general and to FIG. 1 in particular, it will be understood that the illustrations are for the purpose of describing particular embodiments and are not intended to limit the disclosure or appended claims thereto. The drawings are not necessarily to scale, and certain features and certain views of the drawings may be shown exaggerated in scale or in schematic in the interest of clarity and conciseness.

New ion exchangeable glass compositions are continually being developed to offer advantages in glass manufacturability and/or final properties compared to previous glass compositions. Such glasses are used in applications such as, but not limited to, cover glasses, windows, enclosures, and the like in a variety of electronic devices, including displays in entertainment and communication devices.

Presently, such glasses are typically based on two similar glass systems: SiO₂—Al₂O₃—B₂O₃—MgO—Na₂O—P₂O₅ and SiO₂—Al₂O₃—MgO—Na₂O. Due to the presence of boron or phosphorus in the glass, the first group of glasses generally exhibits a high indentation threshold, as measured by Vickers crack indentation experiments, after ion exchange. The presence of boron and phosphorus generates an open structure (i.e., high molar volume) in the glass, which also enhances diffusion for deep ion exchange in these glasses.

Many transition metal oxides may be used to provide glass with color. Such glasses may also be converted to glass-ceramics by post-forming heat treatment. Described herein are glasses that can be chemically strengthened and are colored by transition metals. Most of the glasses described herein are black, with some having high damage resistance and compressive surface layers having high compressive stress and depth of layer after ion exchange. These colored glasses do not require a post-forming heat treatment to produce color. Based on liquidus data, these glasses are fusion formable. However, other processes, such as rolling, slot drawing, and float glass processes may be used to produce these glasses.

In some aspects, the silicate glasses described herein comprise at least about 50 mol % SiO₂; at least about 10 mol % R₂O, where R₂O comprises Na₂O; Al₂O₃, wherein −0.5 mol %≤Al₂O₃(mol %)−R₂O(mol %)≤2 mol %; and B₂O₃, wherein B₂O₃(mol %)−(R₂O(mol %)—Al₂O₃(mol %))≥4.5 mol %. In some embodiments, these glasses comprise at least about 50 mol % SiO₂, from about 9 mol % to about 22 mol % Al₂O₃, from about 3 mol % to about 10 mol % B₂O₃, from about 9 mol % to about 20 mol % Na₂O, from 0 mol % to about 5 mol % K₂O, 0 mol %≤MgO≤6 mol %, and 0 mol %≤ZnO≤6 mol %. In addition, the glasses may optionally comprise at least one of CaO, BaO, and SrO, wherein 0 mol %≤CaO+SrO+BaO≤2 mol %.

In other aspects, the silicate glass comprises at least about 50 mol % SiO₂, at least about 10 mol % R₂O, wherein R₂O comprises Na₂O; Al₂O₃, wherein Al₂O₃(mol %)<R₂O(mol %); and B₂O₃, wherein B₂O₃(mol %)−(R₂O(mol %)—Al₂O₃(mol %))≥2 mol %. In some embodiments, these glasses comprise at least about 50 mol % SiO₂, from about 9 mol % to about 22 mol % Al₂O₃, from about 3 mol % to about 10 mol % B₂O₃, from about 9 mol % to about 20 mol % Na₂O, from 0 mol % to about 5 mol % K₂O, from 0 mol % to about 6 mol % MgO; and from 0 mol % to about 6 mol % ZnO. In addition, the glasses may optionally comprise at least one of CaO, BaO, and SrO, wherein 0 mol %≤CaO+SrO+BaO≤2 mol %.

In still other aspects, the silicate glass comprises at least about 4% P₂O₅ and at least one transition metal colorant, the transition metal oxide colorant comprising at least one of V₂O₅, NiO, CuO, Cr₂O₃, MnO₂, Fe₂O₃, Co₃O₄, Nb₂O₅, and TiO₂ wherein: [M₂O₃(mol %)/RₓO(mol %)]<1.4; or 1.3<[(P₂O₅(mol %)+R₂O(mol %)/M₂O₃(mol %)]≤2.3, where M₂O₃(mol %)=Al₂O₃(mol %)+B₂O₃(mol %), RₓO is the sum of monovalent and divalent cation oxides present in the silicate glass, and R₂O is the sum of divalent cation oxides present in the silicate glass. In some embodiments, [M₂O₃(mol %)/RₓO(mol %)]<1.4 and, in some embodiments, [M₂O₃(mol %)/RₓO(mol %)]<1. In other embodiments, 1.3<[(P₂O₅(mol %)+R₂O(mol %))/M₂O₃(mol %)][(P₂O₅(mol %)+R₂O(mol %))/M₂O₃(mol %)]≤2.3 am, in some embodiments, 1.5<[(P₂O₅(mol %)+R₂O(mol %))/M₂O₃(mol %)]≤2.0. In some embodiments, the glass comprises from about 40 mol % to about 70 mol % SiO₂; from about 11 mol % to about 25 mol % Al₂O₃; from about 4 mol % to about 15 mol % P₂O₅; and from about 13 mol % to about 25 mol % Na₂O and, in some embodiments, from about 50 mol % to about 65 mol % SiO₂; from about 14 mol % to about 20 mol % Al₂O₃; from about 4 mol % to about 10 mol % P₂O₅; and from about 14 mol % to about 20 mol % Na₂O.

In the silicate glass compositions described herein, SiO₂ serves as the primary glass-forming oxide. The concentration of SiO₂ in the glass should be sufficiently high in order to provide the glass with sufficiently high chemical durability that is suitable for some applications such as, for example touch screen applications. However, the melting temperature (200 poise temperature) of pure SiO₂ or glasses having high SiO₂ contents is considered too high, since defects such as fining bubbles may appear during manufacture. Furthermore, SiO₂, compared to most oxides, decreases the level of compressive stress created by ion exchange. Accordingly, the silicate glasses described herein comprise at least 50 mol % SiO₂. In some embodiments, these glasses comprise from about 66 mol % to about 74 mol % SiO₂ and, in other embodiments from about 60 mol % to about 66 mol % SiO₂. In another aspect, the silicate glasses comprise from about 40 mol % to about 70 mol % SiO₂ and, in some embodiments, from about 50 mol % to about 65 mol % SiO₂.

Alumina (Al₂O₃) can also serve as a glass former in these silicate glasses. Like SiO₂, alumina generally increases the viscosity of the melt. In addition, an increase in Al₂O₃ relative to the alkalis or alkaline earths generally results in improved durability of the glass. In some embodiments, −0.5 mol %≤Al₂O₃(mol %)−R₂O(mol %)≤2 mol %. In other embodiments, Al₂O₃(mol %)<R₂O(mol %). The structural role of the aluminum ions depends on the glass composition. When the concentration of alkali oxide(s)[R₂O] is greater than or equal to the concentration of alumina [Al₂O₃], all aluminum is found in tetrahedral coordination with the alkali ions acting as charge-balancers. This is the case for some of the glasses described herein. In other glasses, the concentration of alkali oxide is less than the concentration of aluminum ions, in which case divalent cation oxides (RO) can also charge balance tetrahedral aluminum to various extents. While elements such as calcium, zinc, strontium, and barium behave equivalently to two alkali ions, the high field strength of magnesium ions cause them to not fully charge balance aluminum in tetrahedral coordination, resulting in formation of five- and six-fold coordinated aluminum. Generally, Al₂O₃ plays an extremely important role in ion-exchangeable glasses, since it enables a strong network backbone (i.e., high strain point) while allowing for relatively fast diffusivity of alkali ions. High Al₂O₃ concentrations, however, generally lower the liquidus viscosity. Al₂O₃ concentration therefore needs to be kept in a reasonable range. In some embodiments, the silicate glasses described herein comprise from about 9 mol % to about 22 mol % Al₂O₃ and, in other embodiments, the glasses comprise from about 12 mol % to about 22 mol % Al₂O₃. In another aspect, the glass comprises from about 11 mol % to about 25 mol % Al₂O₃ and, in some embodiments, from about 14 mol % to about 20 mol % Al₂O₃.

The silicate glasses described herein comprise at least about 10 mol % alkali metal oxides R₂O, wherein R₂O includes Na₂O. Alkali metal oxides (Li₂O, Na₂O, K₂O, Rb₂O, and Cs₂O) serve as aids in achieving low melting temperature and low liquidus temperatures of the glass. However, the addition of alkali oxide(s) dramatically increases the coefficient of thermal expansion (CTE) and lowers the chemical durability of the glass. The silicate glasses described herein, in some embodiments, comprise from about 9 mol % to about 20 mol % Na₂O and, in other embodiments, from about 10 mol % to about 20 mol % Na₂O. in another aspect, the glass comprises from about 13 mol % to about 25 mol % Na₂O and, in some embodiments, from about 14 mol % to about 20 mol % Na₂O.

The glasses may also comprise from 0 mol % to about 5 mol % K₂O. To perform ion exchange, the presence of a small alkali oxide such as Li₂O and Na₂O is required to exchange with larger alkali ions (e.g., K+) from a salt bath or other ion exchange medium. Three types of ion exchange can generally be carried out: Na⁺—for-Li exchange, which results in a deep depth of layer but low compressive stress; K⁺—for-Li⁺ exchange, which results in a small depth of layer but a relatively large compressive stress; and K⁺-for-Na exchange, which results in intermediate depth of layer and compressive stress. A sufficiently high concentration of the small alkali oxide is necessary to produce a large compressive stress in the glass, since compressive stress is proportional to the number of alkali ions that are exchanged out of the glass. In some of the example glasses, a small amount of K₂O is introduced into the glass to improve diffusivity and lowers the liquidus temperature, but it generally increases the CTE and decreases CS. Thus, the potassium concentration of the glass is kept at a very low level (e.g., ≤5 mol % and, in some embodiments, <1 mol %) and, in certain embodiments, the glass is free of potassium. In certain embodiments, the silicate glass is free of lithium.

Divalent cation oxides (such as alkaline earth oxides and ZnO) also improve the melting behavior of the glass. With respect to ion exchange performance, however, the presence of divalent cations acts to decrease alkali mobility. The negative effect of divalent cations on ion exchange performance is especially pronounced with the larger divalent cations. Furthermore, the smaller divalent cation oxides (e.g., MgO, ZnO) generally help increase the compressive stress of the glass more than the larger divalent cations. Hence, MgO and ZnO offer several advantages with respect to improved stress relaxation while minimizing the adverse effects on alkali diffusivity. However, when the concentrations of MgO and ZnO in the glass are high, these oxides are prone to form forsterite (Mg₂SiO₄) and gahnite (ZnAl₂O₄) or willemite (Zn₂SiO₄), respectively, thus causing the liquidus temperature of the glass to rise very steeply when the MgO and ZnO contents are above certain levels. In some embodiments, the silicate glass comprises at least about 0.1 mol % of at least one of MgO and ZnO, and in some embodiments, 0 mol %≤MgO≤6 mol % and 0 mol %≤ZnO≤6 mol %. In some embodiments, either MgO or ZnO as the only divalent cation oxide in the glass; i.e., the glass is free of other alkaline earth oxides (CaO, BaO, SrO). In other embodiments, however, the glass may include at least one of CaO, BaO, and SrO, wherein 0 mol %≤CaO+SrO+BaO≤2 mol %.

The glasses described herein comprise B₂O₃ and, in some embodiments, the glass comprises from about 3 mol % to about 10 mol % B₂O₃. In another aspect, the glasses comprises less than about 1 mol % B₂O₃ and, in some embodiments, 0 mol % B₂O₃. The addition of B₂O₃ and P₂O₅ improve the damage resistance of the glass. When boron is not charge balanced by alkali oxides or divalent cation oxides, it will be in trigonal coordination state, and thus open up the structure and provide greater damage resistance. The network around these trigonal coordinated borons is not as rigid as tetrahedrally coordinated ones, the bonds are floppy, and therefore the glasses can tolerate some deformation before crack formation. In some embodiments, the silicate glass comprises greater than 4.5 mol % B₂O₃ in which boron cations are three-fold coordinated. In other embodiments, the glass comprises greater than 2 mol % B₂O₃ in which boron cations are three-fold coordinated and, in some embodiments the silicate glass comprises from about 2 mol % to about 4.5 mol % of three-fold coordinated boron cations. In certain embodiments, B₂O₃(mol %)−(R₂O(mol %)—Al₂O₃(mol %))≥2 mol %, and some embodiments, B₂O₃(mol %)−(R₂O(mol %)—Al₂O₃(mol %))≤4.5 mol %. In some embodiments, B₂O₃(mol %)−(R₂O(mol %)—Al₂O₃(mol %)≥ 4.5 mol %. Furthermore, both boron and phosphorus decrease the melting viscosity and effectively help to suppress zircon breakdown viscosity.

Unlike B₂O₃, P₂O₅ can improve the diffusivity of alkali cations and decrease ion exchange times. In one aspect, P₂O₅ may replace at least a portion of B₂O₃ in the glass such that 4.5 mol %≤B₂O₃ (mol %)+P₂O₅(mol %)≤10 mol %. In another aspect, the glasses described herein may comprise at least 4 mol % P₂O₅, in some embodiments, from about 4 mol % to about 15 mol % P₂O₅ and, in still other embodiments, from about 4 mol % to about 10 mol % P₂O₅. However, the floppy structure formed by boron and phosphorus sacrifice some compressive stress capability where the effect from P₂O₅ is also pronounced. The coordination number change of B₂O₃ on fictive temperature is the source of the variation of indentation threshold with thermal history. The compositions included herein are boron containing glasses. Trigonally coordinated boron in glasses with higher fictive temperatures will partially convert to tetrahedral coordinated when the fictive temperature of the glass decreases. During annealing or heat treatment, the fictive temperature of the glass will be reduced, and the amount of trigonal coordinated boron will therefore decrease. If this change is dramatic, the level of trigonally coordinated boron will not be sufficient to sustain the open glass structure.

In some aspects, the glasses described herein are ion exchanged by those means known in the art such as, for example immersion in a molten salt bath containing salts of the cation that is to replace the cation in the glass. Cations—typically monovalent alkali metal cations that which are present in these glasses are replaced with larger cations—typically monovalent alkali metal cations, although other cations such as Ag⁺ or Tl⁺ may be used—having the same valence or oxidation state. The replacement of smaller cations with larger cations creates a surface layer that is under compression, or compressive stress CS. This layer extends from the surface of the glass into the interior or bulk of the glass to a depth of layer DOL. The compressive stress in the surface layers of the glass are balanced by a tensile stress, or central tension CT, in the interior or inner region of the glass. The ion exchanged glasses, in some embodiments, have a surface layer under a compressive stress of at least about 800 MPa and, in certain embodiments, at least 900 MPa, wherein the layer extends to a depth of layer of at least about 45 μm and, in some embodiments, at least about 30 μm. Compressive stress and depth of layer are measured using those means known in the art. Such means include, but are not limited to measurement of surface stress (FSM) using commercially available instruments such as the FSM-6000, manufactured by Luceo Co., Ltd. (Tokyo, Japan), or the like. Methods of measuring compressive stress and depth of layer are described in ASTM 1422C-99, entitled “Standard Specification for Chemically Strengthened Flat Glass,” and ASTM 1279.19779 “Standard Test Method for Non-Destructive Photoelastic Measurement of Edge and Surface Stresses in Annealed, Heat-Strengthened, and Fully-Tempered Flat Glass,” the contents of which are incorporated herein by reference in their entirety. Surface stress measurements rely upon the accurate measurement of the stress optical coefficient (SOC), which is related to the stress-induced birefringence of the glass. SOC in turn is measured by those methods that are known in the art, such as fiber and four point bend method, both of which are described in ASTM standard C770−98 (2008), entitled “Standard Test Method for Measurement of Glass Stress-Optical Coefficient,” the contents of which are incorporated herein by reference in their entirety, and a bulk cylinder method.

The ion exchanged glasses described herein possess a degree of intrinsic damage resistance (IDR), which may be characterized by the Vickers crack initiation threshold of the ion exchanged glass. In some embodiments, the ion exchanged glass has a Vickers crack initiation threshold of at least about 15 kgf. In some embodiments, the ion exchanged glass has a Vickers crack initiation threshold in a range from about 20 kgf to about 30 kgf and, in other embodiments, at least about 25 kgf. The Vickers crack initiation threshold measurements described herein are performed by applying and then removing an indentation load to the glass surface at a rate of 0.2 mm/min. The maximum indentation load is held for 10 seconds. The crack initiation threshold is defined at the indentation load at which 50% of 10 indents exhibit any number of radial/median cracks emanating from the corners of the indent impression. The maximum load is increased until the threshold is met for a given glass composition. All indentation measurements are performed at room temperature in 50% relative humidity.

In some embodiments, the silicate glasses described herein are black or brown in color. The glasses may be opaque or nearly opaque. In some embodiments, the silicate glass has a transmission of less than 1% at wavelengths in the visible region of the spectrum (about 400 nm to about 770 nm) and, in some embodiments, 0% transmission in the as measured for samples having a thickness of about 1 mm. In some embodiments, the silicate glass has color coordinates a*, b*, and L*, wherein a* is in a range from about 0 to about −6, b* is in a range from about 3 to about −5, and L* is in a range from about 30 to 23.

### Examples

The following examples are provided to illustrate the features and advantages of the glasses described herein and are in no way intended to limit the disclosure and appended claims thereto.

Fifty-four glasses based on four different compositions were prepared. Most of the glasses prepared were black or opaque. The compositions and selected properties of these samples are listed in Tables 1−4. Samples 1-30 (Tables 1a-e) in the following tables have a Na₂O—Al₂O₃—SiO₂ base composition plus one or more transition metal colorants. Samples 31-39 in Tables 2a-b have a base composition “A” (67.35 mol % SiO₂, 12.66 mol % Al₂O₃, 2.36 mol % MgO, 13.73 mol % Na₂O, and 3.73 mol % B₂O₃) plus different combinations of transition metal colorants. Samples 40-57 in Tables 3a-b have a base composition “B” (64.76 mol % SiO₂, 13.94 mol % Al₂O₃, 2.36 mol % MgO, 13.82 mol % Na₂O, and 5 mol % B₂O₃) plus different combinations of transition metal colorants. Samples 58-60 in Table 4 have a base composition “C” (64.76 mol % SiO₂, 13.94 mol % Al₂O₃, 2.36 mol % MgO, 13.82 mol % Na₂O, and 5 mol % B₂O₃) plus different combinations of transition metal colorants.

The compositions of these samples were analyzed by x-ray fluorescence and/or inductively coupled plasma optical emission spectrometry (ICP-OES) plus FES. Anneal and strain points were determined by beam bending viscometry. Softening points were determined by parallel plate viscometry. Glass color was observed on 0.8 or 1 mm thick pieces of crucible melted glasses. The Coefficient of thermal expansion (CTE) reported in the Tables is the average value between room temperature and 300° C. Liquidus temperature was determined in a gradient boat test with 72 hours duration. The liquidus temperature listed for samples 10-21 is the result for the internal reading, the note “Unk” in the tables means that the primary phase is unknown. Elastic moduli were determined by resonant ultrasound spectroscopy. Refractive index is stated for 589.3 nm of the non-colored glasses. Stress optical coefficient (SOC) was determined by the diametral compression method.

Table 5 contains a summary of ion exchange properties of some of the transparent glasses listed in Table 1a. The compressive stress (CS) and depth of layer (DOL) of the samples were obtained as a result of ion exchange treatment of fictivated samples (temperatures are determined to be 60° C. above annealing point) in a molten salt bath of refined grade KNO₃ carried out at 410° C. for 2, 4, and 6 hours. CS and DOL are stated in the units of MPa and μm, respectively. CS and DOL of the visibly opaque black glasses were not measured since they are not transparent at the wave length used for the FSM. Only one colored glass (sample no. 3) in Table 2 was transparent enough to use the FSM.

FIG. 1 contains x-ray diffraction spectra for four sample glasses. The FIG. 1 includes a spectrum of one sample from each base glass. The x-ray diffraction spectra show that all of the samples are non-crystalline.

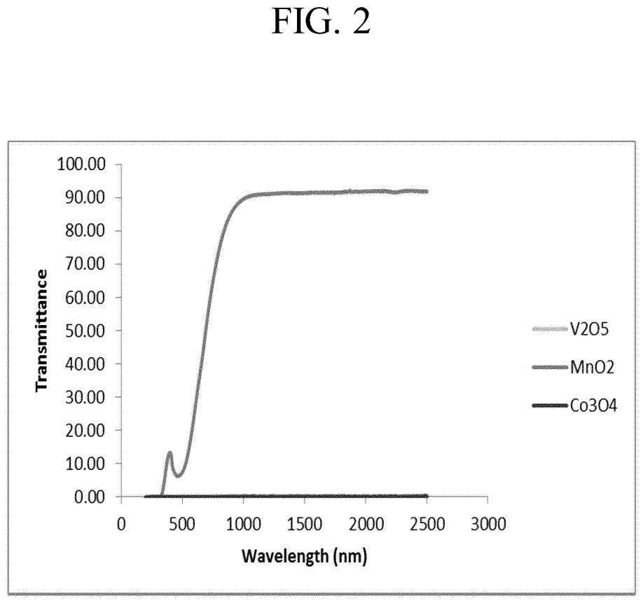

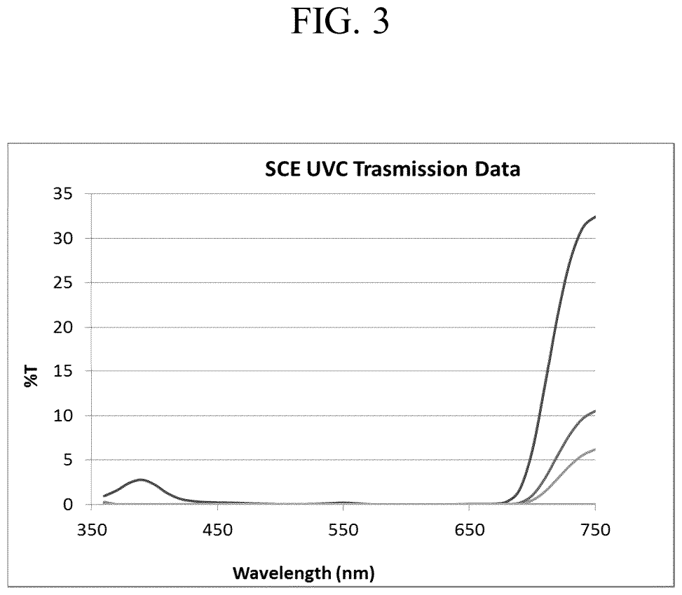

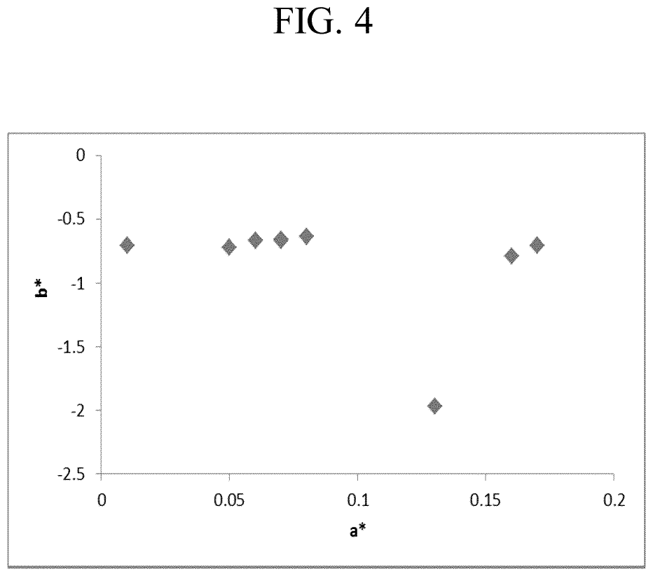

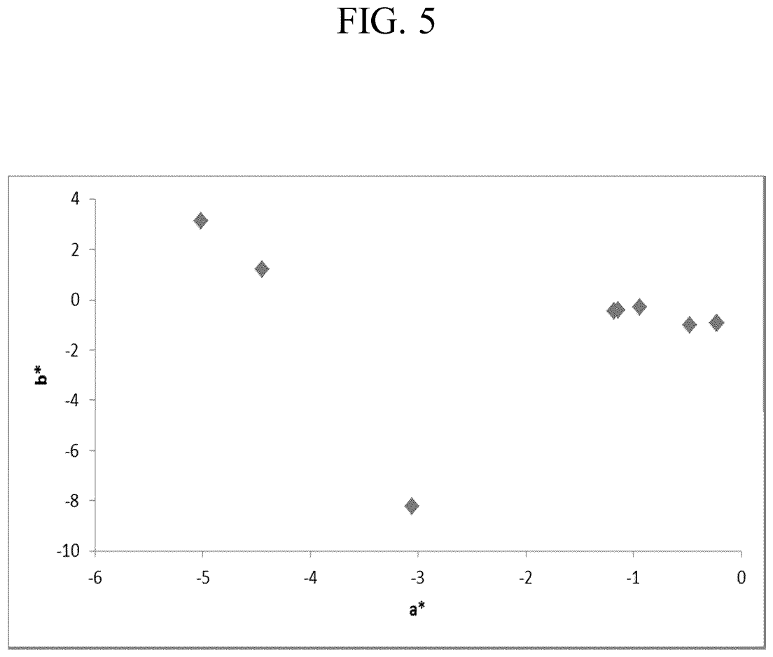

FIG. 2 is a plot of ultraviolet-visible-near infrared (UV-Vis-NIR) transmission spectra of example glasses (glass samples 2, 3, and 5) based on base glass A. Measurements were performed on 1 mm thick glasses. SCE UVC transmission spectra of 0.8 mm thick samples of black glasses based on base glass B are shown in FIG. 3. FIGS. 4 and 5 are plots of reflectance color a* and b* results obtained for black glasses that are based on base glass B and C, respectively.

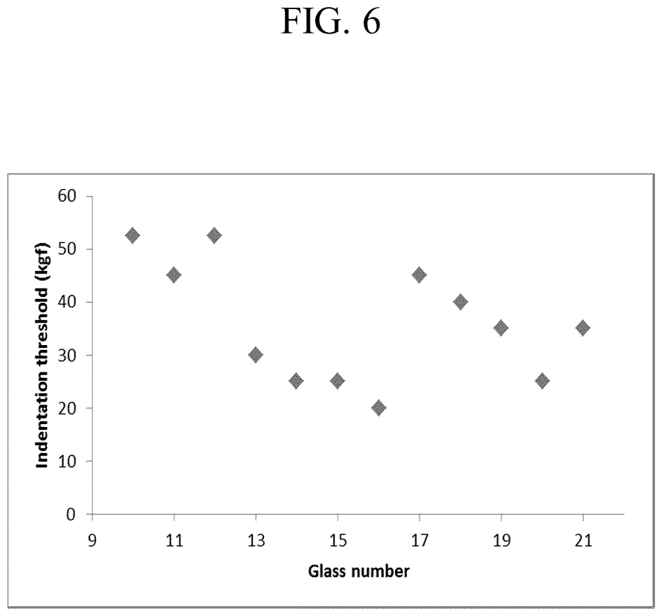

Vickers indentation thresholds are plotted for samples 10-21, which are based on base glass A, in FIG. 6. Indentation threshold measurements were performed on glasses that were fictivated (i.e., heating of the glass to a first temperature at which the glass has a viscosity of less than 1013 poise followed by equilibrating the glass at the first temperature for a predetermined time period, and then quickly quenching the glass to a second temperature below the strain point of the glass) and then ion exchanged in a KNO₃ salt bath at 410° C. for 2 hours.

TABLE 1a
Compositions of samples 1-9, which are based on base glass A.

| | 1 | 2 | 3 | 4 | 5 |
|---|---|---|---|---|---|
| Composition | MgO | V₂O₅ | MnO₂ | Fe₂O₃ | Co₃O₄ |
| (mol %) | added | added | added | added | added |
| SiO₂ | 65.39 | 65.63 | 65.48 | 65.55 | 65.6 |
| Al₂O₃ | 14.46 | 14.46 | 14.48 | 14.43 | 14.51 |
| MgO | 5.12 | 0 | 0 | 0 | 0 |
| Na₂O | 14.95 | 14.82 | 15.49 | 15.1 | 15.28 |
| Nb₂O₅ | | | | | |
| Fe₂O₃ | | | | 4.86 | |
| V₂O₅ | | 5.05 | | | |
| MnO₂ | | | 4.4 | | |
| Co₃O₄ | | | | | 4.55 |
| TiO₂ | | | | | |
| B₂O₃ | | | | | |
| P₂O₅ | | | | | |

| | 6 | 7 | 8 | 9 |
|---|---|---|---|---|
| Composition | Nb₂O₅ | TiO₂ | B₂O₃ | P₂O₅ |
| (mol %) | added | added | added | added |
| SiO2 | 65.68 | 65.6 | 65.72 | 65.82 |
| Al₂O₃ | 14.38 | 14.44 | 14.46 | 14.33 |
| MgO | 0 | 0 | 0 | 0 |
| Na₂O | 14.83 | 14.96 | 14.73 | 14.86 |
| Nb₂O₅ | 5.04 | 0 | 0 | |
| Fe₂O₃ | | | | |
| V₂O₅ | | | | |
| MnO₂ | | | | |
| Co₃O₄ | | | | |
| TiO₂ | | 4.92 | | |
| B₂O₃ | | | 5.0 | |
| P₂O₅ | | | | 4.9 |

TABLE 1b
Properties of samples 10-9, which are based on base glass A.

| Properties | 1 | 2 | 3 | 4 | 5 |
|---|---|---|---|---|---|
| Anneal Pt. | 701.4 | 660.3 | 663.8 | | 609 |
| (° C.) | | | | | |
| Strain Pt. | 649.7 | 614.9 | 613.4 | | 876.1 |
| (° C.) | | | | | |
| Softening Pt. | 956 | 989.3 | 918.6 | | 555.8 |
| (° C.) | | | | | |
| Glass color | T¹ | Black | Brown | Black | Black |
| Density | 2.446 | 2.444 | 2.494 | 2.574 | 2.662 |
| (g/cm³): | | | | | |
| CTE (×10⁻⁷/ | 78.8 | | 81.8 | 80.6 | |
| ° C.) | | | | | |
| Liquidus | | 970 | 1040 | | 1245 |
| Temp (° C.) | | | | | |
| Primary | | Albite | unk | | unk |
| Devit Phase | | | | | |
| Liquidus | | 2.46*10⁶ | | | 2567 |
| Visc. (Poise) | | | | | |
| Poisson's | 0.212 | 0.202 | 0.222 | | 0.225 |
| Ratio | | | | | |
| Shear | 4.402 | 4.495 | 4.324 | | 3.803 |
| Modulus | | | | | |
| (Mpsi) | | | | | |
| Young's | 10.671 | 10.801 | 10.569 | | 9.316 |
| Modulus | | | | | |
| (Mpsi) | | | | | |
| Hardness | | 623 | 609 | | 527 |
| (Non-IX)¹ | | | | | |
| Hardness | | 743 | 710 | | 618 |
| (IX'd)² | | | | | |
| Refractive | 1.5044 | | | | |
| Index | | | | | |

¹Transparent

| Properties | 6 | 7 | 8 | 9 |
|---|---|---|---|---|
| Anneal Pt. (° C.) | 765.8 | 743 | 635.5 | 701 |
| Strain Pt. (° C.) | 713.9 | 689.4 | 581.6 | 641.2 |
| Softening Pt. | 1019.4 | 1017.9 | 917.1 | 992.1 |
| (° C.) | | | | |
| Glass color | L-pink | L-Brown | T | T |
| Density | 2.636 | 2.45 | 2.389 | 2.382 |
| (g/cm³): | | | | |
| CTE (×10⁻⁷/° C.) | 73.9 | | 80.2 | 78.8 |
| Liquidus Temp | | | | |
| (° C.) | | | | |
| Primary Devit | | | | |
| Phase | | | | |
| Liquidus Visc. | | | | |
| (Poise) | | | | |
| Poisson's Ratio | 0.205 | 0.228 | 0.195 | 0.231 |
| Shear Modulus | 4.516 | 4.183 | 3.964 | 3.864 |
| (Mpsi) | | | | |
| Young's | 10.881 | 10.277 | 9.473 | 9.514 |
| Modulus | | | | |
| (Mpsi) | | | | |
| Hardness | | | | |
| (Non-IX)¹ | | | | |
| Hardness | | | | |
| (IX'd)² | | | | |
| Refractive | | | 1.4956 | 1.4872 |
| Index | | | | |

¹Ion exchanged
²Not ion exchanged

TABLE 1c
Compositions of samples 10-21, which are based on base glass A.

| Composition | Glass No. | | | | |
|---|---|---|---|---|---|
| (mol %) | 10 | 11 | 12 | 13 | 14 |
| SiO₂ | 62.08 | 60.02 | 57.15 | 61.97 | 60.07 |
| Al₂O₃ | 14.87 | 14.79 | 14.81 | 14.95 | 14.95 |
| Na₂O | 14.97 | 15.00 | 14.91 | 15.01 | 14.91 |
| Fe₂O₃ | 0.01 | 0.01 | 0.01 | 0.01 | 0.01 |
| V₂O₅ | 4.97 | 4.99 | 5.02 | 5.00 | 5.01 |
| B₂O₃ | 0.00 | 0.00 | 0.00 | 3.00 | 4.99 |
| P₂O₅ | 3.06 | 5.14 | 8.06 | 0.00 | 0.00 |

| Composition | Glass No. | | | |
|---|---|---|---|---|
| (mol %) | 15 | 16 | 17 | 18 |
| SiO₂ | 57.10 | 62.57 | 64.61 | 62.53 |
| Al₂O₃ | 14.95 | 14.56 | 14.65 | 14.77 |
| Na₂O | 14.88 | 14.88 | 14.79 | 14.74 |
| Fe₂O₃ | 0.01 | 0.01 | 0.01 | 0.01 |
| V₂O₅ | 5.03 | 2.95 | 2.96 | 2.92 |
| B₂O₃ | 7.98 | 0.00 | 0.00 | 4.99 |
| P₂O₅ | 0.00 | 4.99 | 2.93 | 0.00 |

| Composition | Glass No. | | |
|---|---|---|---|
| (mol %) | 19 | 20 | 21 |
| SiO₂ | 62.57 | 62.32 | 62.57 |
| Al₂O₃ | 14.85 | 14.90 | 14.85 |
| Na₂O | 64.54 | 14.92 | 14.90 |
| Fe₂O₃ | 14.74 | 0.34 | 0.68 |
| V₂O₅ | 14.70 | 2.50 | 1.99 |
| B₂O₃ | 0.01 | 4.98 | 4.97 |
| P₂O₅ | 2.99 | 0.00 | 0.00 |

TABLE 1d
Properties of samples 10-21, which are based on base glass A.

| Properties | 10 | 11 | 12 | 13 | 14 |
|---|---|---|---|---|---|
| Anneal Pt. | 586.8 | 563.6 | 526 | 553.3 | 529.3 |
| (° C.) | | | | | |
| Strain Pt. | 531.2 | 508.7 | 477.2 | 502.2 | 482.7 |
| (° C.) | | | | | |
| Softening Pt. | 825.1 | 819.4 | 768.5 | 816.6 | 787.4 |
| (° C.) | | | | | |
| Glass color | black | black | black | black | black |
| CTE (×10⁻⁷/ | | | | | |
| ° C.) | | | | | |
| Liquidus | 975 | 950 | 955 | 1030 | 1015 |
| Temp (° C.) | | | | | |
| Primary | Albite | Albite | Unknown | Unknown | Unknown |
| Devit Phase | | | | | |
| Liquidus | | | | | |
| Viscosity | | | | | |
| (Poise) | | | | | |
| Poisson's | 0.228 | 0.265 | 0.248 | 0.25 | 0.244 |
| Ratio | | | | | |
| Shear | 3.677 | 3.578 | 3.517 | 3.665 | 3.577 |
| Modulus | | | | | |
| (Mpsi) | | | | | |
| Young's | 9.031 | 9.049 | 8.782 | 9.161 | 8.897 |
| Modulus | | | | | |
| (Mpsi) | | | | | |
| Refractive | | | | | |
| Index | | | | | |
| SOC³ | | | | | |
| (nm/cm/MPa) | | | | | |
| Color L* | | 26.1 | 27.92 | 26 | 25.76 |
| Color a* | | −0.13 | 0.8 | 0.01 | 0.03 |
| Color b* | | −4.88 | −2.3 | −0.76 | −0.81 |

³Stress optical coefficient

| Properties | 15 | 16 | 17 | 18 | 19 |
|---|---|---|---|---|---|
| Anneal Pt. | 508.8 | 593 | 619.8 | 583.4 | 606.7 |
| (° C.) | | | | | |
| Strain Pt. | 462.5 | 540.4 | 563.3 | 530.5 | 553.7 |
| (° C.) | | | | | |
| Softening Pt. | 751.1 | 877.1 | 912.2 | 852.9 | 889.4 |
| (° C.): | | | | | |
| Glass color | black | brown | brown | brown | brown |
| CTE (×10⁻⁷/ | | | | | |
| ° C.) | | | | | |
| Liquidus | | | | | |
| Temp (° C.) | | | | | |
| Primary Devit | 1020 | >1250 | 965 | 870 | 880 |
| Phase | | | | | |
| Liquidus | Unknown | Unknown | Albite | | |
| Viscosity | | | | | |
| (Poise) | | | | | |
| Poisson's | 0.246 | 0.247 | 0.221 | 0.252 | 0.21 |
| Ratio | | | | | |
| Shear | 3.448 | 3.684 | 3.784 | 3.685 | 3.803 |
| Modulus | | | | | |
| (Mpsi) | | | | | |
| Young's | 8.589 | 9.19 | 9.242 | 9.225 | 9.204 |
| Modulus | | | | | |
| (Mpsi) | | | | | |
| Refractive | | | | | |
| Index: | | | | | |
| SOC | | | | | |
| (nm/cm/MPa) | | | | | |
| Color L* | 26.68 | 24.5 | | 24.96 | 25.06 |
| Color a* | 0.05 | 0.19 | | 0.27 | 0.37 |
| Color b* | −0.97 | −1.01 | | −0.77 | −0.72 |

| Properties | 20 | 21 |
|---|---|---|
| Anneal Pt. (° C.) | 578.3 | 610.6 |
| Strain Pt. (° C.) | 527.4 | 555.2 |
| Softening Pt. | 855.1 | 876.8 |
| (° C.): | | |
| Glass color | black | black |
| CTE (×10⁻⁷/° C.) | | |
| Liquidus Temp | <930 | 1035 |
| (° C.) | | |
| Primary Devit | Unknown | Unknown |
| Phase | | |
| Liquidus | | |
| Viscosity | | |
| (Poise) | | |
| Poisson's Ratio | 0.245 | 0.234 |
| Shear Modulus | 3.781 | 3.846 |
| (Mpsi) | | |
| Young's | 9.413 | 9.489 |
| Modulus | | |
| (Mpsi) | | |
| Refractive | | |
| Index: | | |
| SOC | | |
| (nm/cm/MPa) | | |
| Color L* | | 24.68 |
| Color a* | | 0.07 |
| Color b* | | −0.94 |

TABLE 1e
Compositions and properties of samples 22-30, which are based on base glass A.

| Composition | Glass No. | | | | |
|---|---|---|---|---|---|
| (mol %) | 22 | 23 | 24 | 25 | 26 |
| SiO₂ | 66.51 | 67.51 | 65.51 | 65.51 | 66.51 |
| Al₂O₃ | 14.50 | 14.50 | 14.50 | 14.50 | 14.50 |
| Na₂O | 14.95 | 14.96 | 14.95 | 14.96 | 14.96 |
| MgO | 0.00 | 0.00 | 2.01 | 0.00 | 1.01 |
| Fe₂O₃ | 0.03 | 0.03 | 0.03 | 0.03 | 0.03 |
| NiO | | | | | |
| V₂O₅ | 4.00 | 3.00 | 3.00 | 3.00 | 3.00 |
| Co₃O₄ | | | | | |
| P₂O₅ | | | | 2.00 | |
| CaO | | | | | |
| Properties | | | | | |
| Glass Color | | | | | |
| Liquidus Visc | | | | | |
| (kPoise) | | | | | |
| Color L* | 25.10 | 24.82 | 25.02 | 24.69 | 25.02 |
| Color a* | 0.11 | 0.49 | 1.06 | 0.34 | 0.46 |
| Color b* | −0.82 | −0.55 | −0.18 | −0.76 | −0.86 |

| Composition | Glass No. | | | |
|---|---|---|---|---|
| (mol %) | 27 | 28 | 29 | 30 |
| SiO₂ | 67.01 | 59.83 | 59.53 | 59.28 |
| Al₂O₃ | 14.51 | 15.25 | 15.17 | 15.11 |
| Na₂O | 14.95 | 15.67 | 15.59 | 15.52 |
| MgO | 0.00 | 2.86 | 2.85 | 2.84 |
| Fe₂O₃ | 0.03 | 0.36 | 0.72 | 0.36 |
| NiO | | 0.76 | 0.77 | 1.54 |
| V₂O₅ | 3.00 | | | |
| Co₃O₄ | | 0.24 | 0.36 | 0.36 |
| P₂O₅ | | 4.87 | 4.85 | 4.83 |
| CaO | 0.5 | | | |
| Properties | | | | |
| Glass Color | | | | |
| Liquidus Visc | | | | |
| (kPoise) | | | | |
| Color L* | 24.82 | | | |
| Color a* | 0.41 | | | |
| Color b* | −0.68 | | | |
| CaO | 24.82 | | | |

TABLE 2a
Compositions of samples 31-39, which are based on base glass B.

| | Glass No. | | | | |
|---|---|---|---|---|---|
| | Base | | | | |
| Composition | Glass | | | | |
| (mol %) | B | 31 | 32 | 33 | 34 |
| SiO₂ | 67.35 | 66.60 | 66.30 | 66.05 | 67.91 |
| Al₂O₃ | 12.66 | 12.53 | 12.47 | 12.42 | 12.77 |
| MgO | 2.36 | 2.34 | 2.32 | 2.31 | 0.00 |
| Na₂O | 13.73 | 13.50 | 13.44 | 13.39 | 13.76 |
| B₂O₃ | 3.73 | 3.62 | 3.60 | 3.59 | 3.69 |
| Fe₂O₃ | | 0.33 | 0.67 | 0.33 | 0.68 |
| Co₃O₄ | | 0.22 | 0.33 | 0.33 | 0.34 |
| NiO | | 0.71 | 0.72 | 1.43 | 0.72 |
| SnO₂ | 0.09 | 0.09 | 0.08 | 0.08 | 0.09 |
| Composition | Glass No. | | | | |
| (mol %) | 35 | 36 | 37 | 38 | 39 |
| SiO₂ | 67.44 | 66.98 | 67.65 | 67.19 | 66.73 |
| Al₂O₃ | 12.69 | 12.60 | 12.72 | 12.64 | 12.55 |
| MgO | 0.67 | 1.33 | 0.00 | 0.67 | 1.33 |
| Na₂O | 13.67 | 13.58 | 13.71 | 13.62 | 13.53 |
| B₂O₃ | 3.67 | 3.65 | 3.68 | 3.65 | 3.63 |
| Fe₂O₃ | 0.67 | 0.67 | 0.34 | 0.34 | 0.34 |
| Co₃O₄ | 0.34 | 0.33 | 0.34 | 0.33 | 0.33 |
| NiO | 0.72 | 0.72 | 1.44 | 1.44 | 1.43 |
| SnO₂ | 0.09 | 0.08 | 0.09 | 0.09 | 0.08 |

TABLE 2b
Properties of samples 31-39, which are based on base glass B.

| | Base | | | | |
|---|---|---|---|---|---|
| Properties | Glass B | 31 | 32 | 33 | 34 |
| Anneal Pt. | 631 | | | | |
| (° C.) | | | | | |
| Strain Pt. | 578 | | | | |
| (° C.) | | | | | |
| Softening Pt. | 903 | | | | |
| (° C.): | | | | | |
| Glass color | T | Black | Black | Black | Black |
| Density | 2.394 | | | | |
| (g/cm³) | | | | | |
| CTE (×10⁻⁷/ | 75.4 | | | | |
| ° C.) | | | | | |
| Liquidus | 1005 | 1190 | 1265 | 1200 | 1190 |
| Temp (° C.) | | | | | |
| Primary | Forsterite | Forsterite- | Forsterite- | Forsterite- | Spinel- |
| Devit Phase | | like | like | like | like |
| Liquidus | 2.2 × 10⁶ | 4.1 × 10⁴ | 1.3 × 10⁴ | 2.9 × 10⁴ | 7.8 × 10⁴ |
| Viscosity | | | | | |
| (Poise) | | | | | |
| Poisson's | 0.2 | | | | |
| Ratio | | | | | |
| Shear | 4.157 | | | | |
| Modulus | | | | | |
| (Mpsi): | | | | | |
| Young's | 9.975 | | | | |
| Modulus | | | | | |
| (Mpsi) | | | | | |
| Refractive | 1.496 | | | | |
| Index | | | | | |
| SOC (nm/ | 32.2 | | | | |
| cm/MPa) | | | | | |
| Color L* | | 24.05 | 24.09 | 24.09 | 24.09 |
| Color a* | | 0.06 | 0.07 | 0.07 | 0.05 |
| Color b* | | −0.67 | −0.67 | −0.66 | −0.72 |
| Properties | 35 | 36 | 37 | 38 | 39 |
| Anneal Pt. | | | | | |
| (° C.) | | | | | |
| Strain Pt. | | | | | |
| (° C.) | | | | | |
| Softening Pt. | | | | | |
| (° C.): | | | | | |
| Glass color | Black | Black | Black | Black | Black |
| Density | | | | | |
| (g/cm³) | | | | | |
| CTE (×10⁻⁷/ | | | | | |
| ° C.) | | | | | |
| Liquidus | 1175 | 1165 | | | |
| Temp (° C.) | | | | | |
| Primary | Spinel-like | Ni—Mg- | Patty-NiO | Patty-NiO | Patty-NiO |
| Devit | | Forsterite | | | |
| Phase | | | | | |
| Liquidus | 6.6*10⁴ | 7.9*10⁴ | XRD | XRD | XRD |
| Viscosity | | | | | |
| (Poise) | | | | | |
| Poisson's | | | | | |
| Ratio | | | | | |
| Shear | | | | | |
| Modulus | | | | | |
| (Mpsi): | | | | | |
| Young's | | | | | |
| Modulus | | | | | |
| (Mpsi): | | | | | |
| Refractive | | | | | |
| Index: | | | | | |
| SOC (nm/ | | | | | |
| cm/MPa): | | | | | |
| Color L* | 24.06 | 24.11 | 24.39 | 24.25 | 24.23 |
| Color a* | 0.01 | 0.08 | 0.13 | 0.16 | 0.17 |
| Color b* | −0.71 | −0.64 | −1.97 | −0.79 | −0.71 |

TABLE 3a
Compositions of samples 40-57, which are based on base glass C.

| | Glass No. | | | | |
|---|---|---|---|---|---|
| | Base | | | | |
| Composition | Glass | | | | |
| (mol %) | C | 40 | 41 | 42 | 43 |
| SiO₂ | 64.76 | 64.07 | 64.15 | 63.55 | 63.63 |
| Al₂O₃ | 13.94 | 13.77 | 13.78 | 13.66 | 13.68 |
| MgO | 2.36 | 2.42 | 2.41 | 2.40 | 2.40 |
| Na₂O | 13.82 | 13.65 | 13.66 | 13.53 | 13.56 |
| B₂O₃ | 5 | 5.09 | 5.10 | 5.05 | 5.06 |
| Fe₂O₃ | | 0.00 | 0.00 | 0.00 | 0.00 |
| Co₃O₄ | | 0.11 | 0.11 | 0.22 | 0.33 |
| MnO₂ | | 0.61 | 0.61 | 1.20 | 1.20 |
| NiO | | 0.00 | 0.00 | 0.00 | 0.00 |
| Cr₂O₃ | | 0.13 | 0.13 | 0.26 | 0.00 |
| SnO₂ | 0.08 | 0.09 | 0.00 | 0.08 | 0.08 |
| Composition | Glass No. | | | | |
| (mol %) | 44 | 45 | 46 | 47 | 48 |
| SiO₂ | 63.90 | 64.10 | 63.85 | 63.90 | 63.94 |
| Al₂O₃ | 13.74 | 13.78 | 13.72 | 13.74 | 13.74 |
| MgO | 2.41 | 2.41 | 2.40 | 2.41 | 2.40 |
| Na₂O | 13.61 | 13.66 | 13.60 | 13.61 | 13.62 |
| B₂O₃ | 5.08 | 5.10 | 5.07 | 5.08 | 5.08 |
| Fe₂O₃ | 0.41 | 0.00 | 0.00 | 0.41 | 0.41 |
| Co₃O₄ | 0.11 | 0.11 | 0.16 | 0.11 | 0.00 |
| MnO₂ | 0.60 | 0.00 | 0.00 | 0.60 | 0.75 |
| NiO | 0.00 | 0.70 | 1.05 | 0.00 | 0.00 |
| Cr₂O₃ | 0.00 | 0.00 | 0.00 | 0.00 | 0.00 |
| SnO₂ | 0.09 | 0.09 | 0.09 | 0.09 | 0.00 |
| | Glass No. | | | | |
| | Base | | | | |
| Composition | Glass | | | | |
| (mol %) | C | 49 | 50 | 51 | 52 |
| SiO₂ | 64.76 | 64.00 | 64.07 | 63.38 | 63.86 |
| Al₂O₃ | 13.94 | 13.76 | 13.77 | 13.62 | 13.73 |
| MgO | 2.36 | 2.41 | 2.41 | 2.39 | 2.41 |
| Na₂O | 13.82 | 13.64 | 13.65 | 13.50 | 13.60 |
| B₂O₃ | 5 | 5.09 | 5.09 | 5.04 | 5.08 |
| Fe₂O₃ | | 0.00 | 0.00 | 0.00 | 0.68 |
| Co₃O₄ | | 0.11 | 0.11 | 0.22 | 0.22 |
| NiO | | 0.71 | 0.71 | 1.43 | 0.00 |
| Cr₂O₃ | | 0.13 | 0.13 | 0.26 | 0.27 |
| CuO | | 0.00 | 0.00 | 0.00 | 0.00 |
| SnO₂ | 0.08 | 0.09 | 0.00 | 0.08 | 0.09 |
| Composition | Glass No. | | | | |
| (mol %) | 53 | 54 | 55 | 56 | 57 |
| SiO₂ | 63.81 | 62.98 | 63.50 | 63.26 | 63.43 |
| Al₂O₃ | 13.71 | 13.53 | 13.65 | 13.60 | 13.63 |
| MgO | 2.39 | 2.36 | 2.40 | 2.39 | 2.39 |
| Na₂O | 13.59 | 13.41 | 13.53 | 13.48 | 13.50 |
| B₂O₃ | 5.07 | 5.00 | 5.05 | 5.03 | 5.04 |
| Fe₂O₃ | 0.34 | 0.51 | 0.68 | 0.34 | 0.42 |
| Co₃O₄ | 0.22 | 0.34 | 0.34 | 0.34 | 0.28 |
| NiO | 0.72 | 0.72 | 0.72 | 1.44 | 0.90 |
| Cr₂O₃ | 0.00 | 0.00 | 0.00 | 0.00 | 0.27 |
| CuO | 0.00 | 1.02 | 0.04 | 0.04 | 0.04 |
| SnO₂ | 0.09 | 0.09 | 0.09 | 0.08 | 0.09 |

TABLE 3b
Compositions of samples 40-57, which are based on base glass C.

| | Base | | | | |
|---|---|---|---|---|---|
| Properties | Glass C | 40 | 41 | 42 | 43 |
| Anneal Pt. | 625 | | | | |
| (° C.) | | | | | |
| Strain Pt. (° C.) | 572 | | | | |
| Softening Pt. | 895 | | | | |
| (° C.): | | | | | |
| Glass color | T | Black | Black | Green | Black |
| | | | | Black | |
| Density | 2.396 | | | | |
| (g/cm³) | | | | | |
| CTE (×10⁻⁷/ | 75.0 | | | | |
| ° C.) | | | | | |
| Liquidus | 1000 | | | | |
| Temp (° C.) | | | | | |
| Primary Devit | Nepheline | | | | |
| Phase | | | | | |
| Liquidus | 2.4*10⁶ | | | | |
| Viscosity | | | | | |
| (Poise) | | | | | |
| Poisson's | 0.17 | | | | |
| Ratio | | | | | |
| Shear | 4.05 | | | | |
| Modulus | | | | | |
| (Mpsi): | | | | | |
| Young's | 9.46 | | | | |
| Modulus | | | | | |
| (Mpsi): | | | | | |
| Refractive | 1.497 | | | | |
| Index: | | | | | |
| SOC | 32.7 | | | | |
| (nm/cm/MPa): | | | | | |
| Color L* | | 24.53 | 24.66 | 30.94 | |
| Color a* | | −1.18 | −0.94 | −3.06 | |
| Color b* | | −0.45 | −0.28 | −8.24 | |
| Properties | 44 | 45 | 46 | 47 | 48 |
| Anneal Pt. | | | | | |
| (° C.) | | | | | |
| Strain Pt. (° C.) | | | | | |
| Softening Pt. | | | | | |
| (° C.): | | | | | |
| Glass color | Black | Black | Black | Black | Dark |
| | | | | | Brown |
| Density | | | | | |
| (g/cm³) | | | | | |
| CTE (×10⁻⁷/ | | | | | |
| ° C.) | | | | | |
| Liquidus | | | | | |
| Temp (° C.) | | | | | |
| Primary Devit | | | | | |
| Phase | | | | | |
| Liquidus | | | | | |
| Viscosity | | | | | |
| (Poise) | | | | | |
| Poisson's | | | | | |
| Ratio | | | | | |
| Shear | | | | | |
| Modulus | | | | | |
| (Mpsi): | | | | | |
| Young's | | | | | |
| Modulus | | | | | |
| (Mpsi): | | | | | |
| Refractive | | | | | |
| Index: | | | | | |
| SOC | | | | | |
| (nm/cm/MPa): | | | | | |
| Color L* | | | 25.45 | | |
| Color a* | | | −1.14 | | |
| Color b* | | | −0.43 | | |
| | Base | | | | |
| Properties | Glass C | 49 | 50 | 51 | 52 |
| Anneal Pt. | 625 | | | | |
| (° C.) | | | | | |
| Strain Pt. | 572 | | | | |
| (° C.) | | | | | |
| Softening Pt. | 895 | | | | |
| (° C.) | | | | | |
| Glass color | Trans- | Black | Black | Green | Blue |
| | parent | | | | Green |
| Density | 2.396 | | | | |
| (g/cm³) | | | | | |
| CTE (×10⁻⁷/ | 75.0 | | | | |
| ° C.) | | | | | |
| Liquidus | 1000 | 1075 | 1140 | 1120 | |
| Temp (° C.) | | | | | |
| Primary Devit | Nepheline | | | | |
| Phase | | | | | |
| Liquidus | 2.4*10⁶ | 4.5 × 10⁵ | 8.8 × 10⁴ | 1.0 × 10⁵ | |
| Viscosity | | | | | |
| (Poise) | | | | | |
| Poisson's | 0.17 | 0.17 | | | |
| Ratio | | | | | |
| Shear | 4.05 | 4.05 | | | |
| Modulus | | | | | |
| (Mpsi): | | | | | |
| Young's | 9.46 | 9.46 | | | |
| Modulus | | | | | |
| (Mpsi): | | | | | |
| Refractive | 1.497 | 1.497 | | | |
| Index | | | | | |
| SOC | 32.7 | 32.7 | | | |
| (nm/cm/MPa) | | | | | |
| Color L* | | 29.62 | 29.17 | | |
| Color a* | | −5.02 | −4.45 | | |
| Color b* | | 3.13 | 1.21 | | |
| Properties | 53 | 54 | 55 | 56 | 57 |
| Anneal Pt. | 625 | | | | |
| (° C.) | | | | | |
| Strain Pt. | 572 | | | | |
| (° C.) | | | | | |
| Softening Pt. | 895 | | | | |
| (° C.) | | | | | |
| Glass color | Trans- | Black | Brown | Black | Black |
| | parent | | Black | | |
| Density | 2.396 | | | | |
| (g/cm³) | | | | | |
| CTE (×10⁻⁷/ | 75.0 | | | | |
| ° C.) | | | | | |
| Liquidus | 1000 | | | | |
| Temp (° C.) | | | | | |
| Primary | Nepheline | | | | |
| Devit Phase | | | | | |
| Liquidus | 2.4*10⁶ | | | | |
| Viscosity | | | | | |
| (Poise) | | | | | |
| Poisson's | 0.17 | | | | |
| Ratio | | | | | |
| Shear | 4.05 | | | | |
| Modulus | | | | | |
| (Mpsi): | | | | | |
| Young's | 9.46 | | | | |
| Modulus | | | | | |
| (Mpsi): | | | | | |
| Refractive | 1.497 | | | | |
| Index | | | | | |
| SOC | 32.7 | | | | |
| (nm/cm/MPa) | | | | | |
| Color L* | | 24.36 | | 24.17 | 24.17 |
| Color a* | | −0.48 | | −0.23 | −0.22 |
| Color b* | | −1.01 | | −0.95 | −0.95 |

TABLE 4
Compositions and properties of samples 58-60,
which are based on base glass D.

| | Glass No. | | | |
|---|---|---|---|---|
| | Base Glass | | | |
| Composition (mol %) | D | 58 | 59 | 60 |
| SiO₂ | 60.69 | 59.83 | 59.53 | 59.12 |
| Al₂O₃ | 15.44 | 15.25 | 15.17 | 15.07 |
| MgO | 2.90 | 2.86 | 2.85 | 2.83 |
| Na₂O | 15.86 | 15.67 | 15.59 | 15.48 |
| P2O5 | 4.94 | 4.87 | 4.85 | 4.82 |
| CaO | 0.05 | 0.05 | 0.05 | 0.05 |
| Fe₂O₃ | | 0.36 | 0.72 | 0.36 |
| Co₃O₄ | | 0.24 | 0.36 | 0.35 |
| NiO | | 0.76 | 0.77 | 1.54 |
| Cr₂O₃ | | 0.00 | 0.00 | 0.28 |
| SnO₂ | 0.08 | 0.11 | 0.11 | 0.11 |
| Properties | 5318-Base | | | |
| Anneal Pt. (° C.) | 625 | | | |
| Strain Pt. (° C.) | 572 | | | |
| Softening Pt. (° C.) | 895 | | | |
| Glass color | T | Black | Black | Black |
| Density (g/cm³) | 2.396 | | | |
| CTE (×10⁻⁷/° C.) | 75.0 | | | |
| Liquidus Temp (° C.) | 1000 | 1075 | 1140 | 1120 |
| Primary Devit Phase | Nepheline | Unknown | Unknown | Unknown |
| Liquidus Viscosity | 2.4 × 10⁶ | 4.5 × 10⁵ | 8.8 × 10⁴ | 1.0 × 10⁵ |
| (Poise) | | | | |
| Poisson's Ratio | 0.17 | | | |
| Shear Modulus (Mpsi): | 4.05 | | | |
| Young's Modulus | 9.46 | | | |
| (Mpsi): | | | | |
| Refractive Index | 1.497 | | | |
| SOC (nm/cm/MPa) | 32.7 | | | |
| Color L* | | 24.43 | 24.27 | 24.24 |
| Color a* | | 0.92 | 0.16 | 0.15 |
| Color b* | | −4.41 | −0.96 | −0.94 |

TABLE 5
Ion exchange properties of transparent glasses listed in Table 1a.

| | Oxide | | | | | | |
|---|---|---|---|---|---|---|---|
| | added | CS | CS | CS | DOL | DOL | DOL |
| | to Base | (MPa) | (MPa) | (MPa) | (μm) | (μm) | (μm) |
| Sample | Glass | (2 h) | (4 h) | (6 h) | (2 h) | (4 h) | (6 h) |
| 1 | MgO | | 1131 | 1119 | | 36.2 | 41.9 |
| 3 | MnO₂ | 1063 | | | 34 | | |
| 8 | B₂O₃ | 904 | 875 | 874 | 33.6 | 45.4 | 53.5 |
| 9 | P₂O₅ | 760 | 731 | 723 | 62.8 | 86.1 | 99.7 |

While typical embodiments have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

1. A silicate glass comprising:
from about 60 mol % to 66 mol % SiO₂;
from about 9 mol % to about 22 mol % Al₂O₃;
at least about 10 mol % R₂O, where R₂O is a total amount of Li₂O, Na₂O, K₂O, Rb₂O, and Cs₂O;
from about 3 mol % to less than or equal to 8.0 mol % B₂O₃; and
at least 0.11 mol % of at least one transition metal oxide colorant, the transition metal oxide colorant comprising at least one of V₂O₅, NiO, CuO, Cr₂O₃, MnO₂, Fe₂O₃, Co₃O₄, or combinations thereof.

2. The silicate glass of claim 1, wherein the silicate glass exhibits color coordinates:
L*: 23 to 30;
a*: −6 to 0; and
b*: −5 to 3.

3. The silicate glass of claim 2, wherein the silicate glass is black and exhibits color coordinates:
L*: 24 to 30;
a*: −4.5 to 0.5; and
b*: −1.1 to 1.3.

4. The silicate glass of claim 1, wherein the silicate glass exhibits a transmission of less than 1% at each wavelength in the range of from 400 nm to 770 nm.

5. The silicate glass of claim 1, wherein the silicate glass is opaque.

6. The silicate glass of claim 1, wherein the silicate glass contains less than about one inclusion per kilogram of silicate glass, the inclusion having a diameter of at least 50 μm.

7. The silicate glass of claim 1, wherein the silicate glass composition comprises:
from about 14 mol % to about 20 mol % Al₂O₃; and
from 0 mol % to about 5 mol % K₂O.

8. The silicate glass of claim 1, wherein [M₂O₃(mol %)/RₓO(mol %)]<1.4, where M₂O₃(mol %)=Al₂O₃(mol %)+B₂O₃(mol %), RₓO is the sum of monovalent and divalent cation oxides present in the silicate glass.

9. The silicate glass of claim 1, wherein 0.6<[M₂O₃ (mol %)/RₓO(mol %)]<1.4, where M₂O₃(mol %)=Al₂O₃(mol %)+B₂O₃(mol %), RₓO is the sum of monovalent and divalent cation oxides present in the silicate glass.

10. The silicate glass of claim 1, wherein the silicate glass comprises at least about 0.1 mol % of at least one of MgO and ZnO.

11. The silicate glass of claim 10, wherein the silicate glass comprises:
$$0 mol \% \leq MgO \leq 6 mol \% ; and \\ 0 mol \% \leq ZnO \leq 6 mol \% .$$

12. The silicate glass of claim 1, wherein:
$$0 mol \% \leq {V}_{2} {O}_{5} \leq 6 mol \% , \\ 0 mol \% \leq NiO \leq 6 mol \% , \\ 0 mol \% \leq CuO \leq 6 mol \% , \\ 0 mol \% \leq {Cr}_{2} {O}_{3} \leq 6 mol \% , \\ 0 mol \% \leq {MnO}_{2} \leq 6 mol \% , \\ 0 mol \% \leq {Fe}_{2} {O}_{3} \leq 6 mol \% , and \\ 0 mol \% \leq {Co}_{3} {O}_{4} \leq 6 mol \% .$$

13. The silicate glass of claim 1, wherein the silicate glass has a Vickers crack initiation threshold of at least 25 kgf.

14. The silicate glass of claim 1, wherein the silicate glass has a layer under a compressive stress of at least about 600 MPa, the layer extending from a surface of the silicate glass into the silicate glass to a depth of layer of at least about 30 μm.

15. The silicate glass of claim 1, wherein B₂O₃(mol %)−(R₂O(mol %)−Al₂O₃(mol %))≥2 mol %.

16. The silicate glass of claim 15, wherein B₂O₃(mol %)−(R₂O(mol %)−Al₂O₃(mol %))≥4.5 mol %.

17. The silicate glass of claim 1, wherein Al₂O₃(mol %)−R₂O(mol %)≤2 mol %.

18. The silicate glass of claim 1, wherein [(P₂O₅(mol %)+R₂O(mol %))/M₂O₃(mol %)]≤2.0.

19. The silicate glass of claim 1, wherein the silicate glass forms at least a portion of a cover plate, a touch screen, a watch crystal, a solar concentrator, a window, a screen, or a container.

20. A silicate glass comprising:
from about 60 mol % to 66 mol % SiO₂;
from about 14 mol % to about 20 mol % Al₂O₃;
at least about 10 mol % R₂O, where R₂O is a total amount of Li₂O, Na₂O, K₂O, Rb₂O, and Cs₂O;
from 0 mol % to about 5 mol % K₂O;
from about 3 mol % to less than or equal to 10 mol % B₂O₃; and
at least 0.11 mol % of at least one transition metal oxide colorant, the transition metal oxide colorant comprising at least one of V₂O₅, NiO, CuO, Cr₂O₃, MnO₂, Fe₂O₃, or Co₃O₄,
wherein the silicate glass exhibits color coordinates:
L*: 24 to 30;
a*: −4.5 to 0.5;
b*: −1.1 to 1.3, and
wherein 0.6<[M₂O₃(mol %)/RₓO(mol %)]<1.4, where M₂O₃(mol %)=Al₂O₃(mol %)+B₂O₃(mol %), where RₓO is the sum of monovalent and divalent cation oxides present in the silicate glass.
